(19) United States
(12) Patent Application Publication
(10) Pub. No.: US 2003/0007358 A1
(43) Pub. Date: Jan. 9, 2003

(54) Variable, phantom, 3-D stand lamp

(76) Inventor: Liu Yi-Chen, Taipei City (TW)

Correspondence Address: YI-CHEN, LIU, P.O. BOX 7-820, TAIPEI CITY, TW

(21) Appl. No.: 09/900,824

(22) Filed: Jul. 9, 2001

(51) Int. Cl. F21V 1/00

(52) U.S. Cl. 362/317

(57) ABSTRACT

What is particularly worthy of illustration is that, the interlacing meshes of the upper circle and the lower circle are arranged in S-shaped curves, in both inner positions and outer positions. The purpose of the arrangement is that, the glass rods are inserted into the meshes, and slots are formed between the glass rods; and pass through the slots is the light, which is partly hidden and partly visible. Therefore, it creates a polychrome, phantom, project light source.

### BACKGROUND OF THE INVENTION

1. Field of the Invention

This invention is about a variable, phantom, 3-D stand lamp. It consists of an upper circle and a lower circle. Between the two circles are three axes that divide the space. Colorful glass rods are inserted into meshes paired opposite in the upper circle and the lower circle respectively, so that the inner and outer encircling glass rods are crossed in curves but remain separated. The consequence is that, the ends of the glass rods seem to project colorful light as if they are light sources. The concave circle track of the base and the circle track of the cover disk are found next to each other, and in between them is inserted a circular pad, forming an upper buffer, position-fixing body and a lower one, so as to prevent the glass rods from losing their functions due to crushing or breaking apart after a collision. The colors of the light passing through the glass rods are bright, interlacing and variable. The combination of colors can be adjusted and matched freely, according to the surroundings, thus enhancing its function of polychrome, phantom, project light source.

2. Description of the Prior Art

The light emitted by light bulbs is important to human vision at night. Lighting, whether for the purpose of household, industry or esthetics, is ubiquitous. Desk lamps, stand lamps, esthetic lamps and chandeliers, and other lighting, are widely used at home or office. As regards the combination and composition of stand lamps, the tradition is that, on a lamp stand, there is a column, which holds a lampshade. The design is never flexible or innovative. To promote their sales, manufactures, in the past, always resorted to the variation of the patterns or figures printed on the surface of the lampshade. Seldom was there any breakthrough or innovation with respect to the design of the structure of the lampshade. As a result, the way light is projected remains unchanged. In response to the advent of e-era, which is characterized by interactive markets, sophisticated function and practical usage, it is necessary to make proof in the design of stand lamps.

### SUMMARY OF THE INVENTION

The primary purpose of this invention is to create a variable, phantom, 3-D stand lamp. In particular, the design involves the combination of a lampshade coil, a circular pad, mesh-shaped circles, axes, glass rods and a base. The structural combination is of practical usage, that is, the colors of the light passing through the glass rods are bright, interlacing and variable. The combination of colors can be adjusted and matched freely, according to the surroundings, thus enhancing its function of polychrome, phantom, project light source.

The secondary purpose of this invention is to create a variable, phantom, 3-D stand lamp. It consists of an upper circle and a lower circle. Between the two circles are three axes that divide the space. Colorful glass rods are inserted into meshes paired opposite in the upper circle and the lower circle respectively.

Another purpose of this invention is to create a variable, phantom, 3-D stand lamp. The inner and outer encircling glass rods are crossed in curves but remain separated, and the ends of the glass rods seem to project colorful light as if they are light sources.

Another purpose of this invention is to create a variable, phantom, 3-D stand lamp. The concave circle track of the base and the circle track of the cover disk are found next to each other, and in between them is inserted a circular pad, forming an upper buffer, position-fixing body and a lower one, so as to prevent the glass rods from losing their functions due to crushing or breaking apart after a collision.

### BRIEF DESCRIPTION OF THE DRAWINGS

FIG. 1 shows the structure of this invention.

FIG. 2 illustrates the components of this invention.

FIG. 3 illustrates the upper circle and the lower circle, separated by a suitable distance.

FIG. 4 illustrates that, in between the upper circle and the lower circle, there is a circular pad, which fixes the positions of the axes and glass rods.

FIG. 5 illustrates that glass rods are inserted into the interlacing holes of the upper circle and the lower circle, and the interlacing glass rods cross each other.

FIG. 6 depicts a sectional view of the structure of this invention, and illustrates how the interlacing glass rods emit light.

FIG. 7 depicts another project light source of this invention.

FIG. 8 illustrates how the appearance of this invention can be changed.

### DETAILED DESCRIPTION OF THE PREFERRED EMBODIMENT

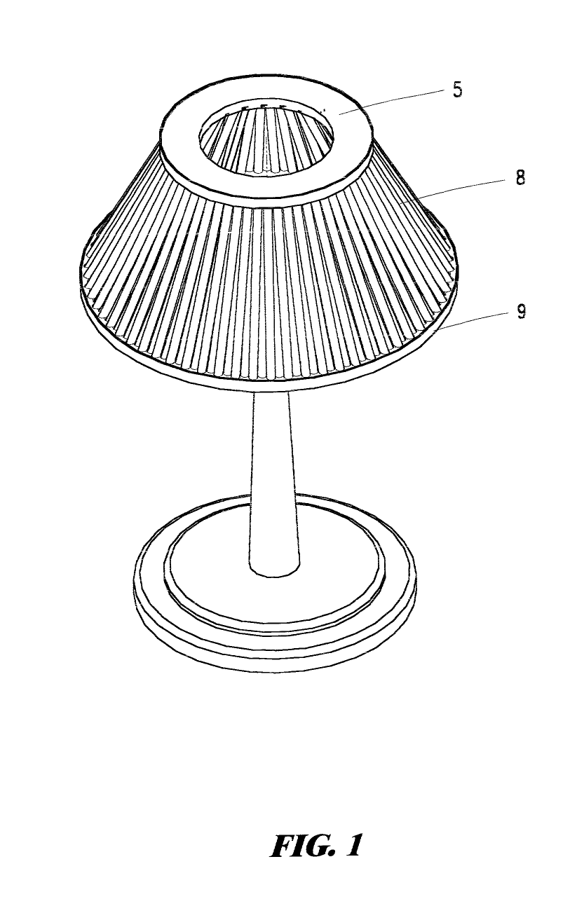

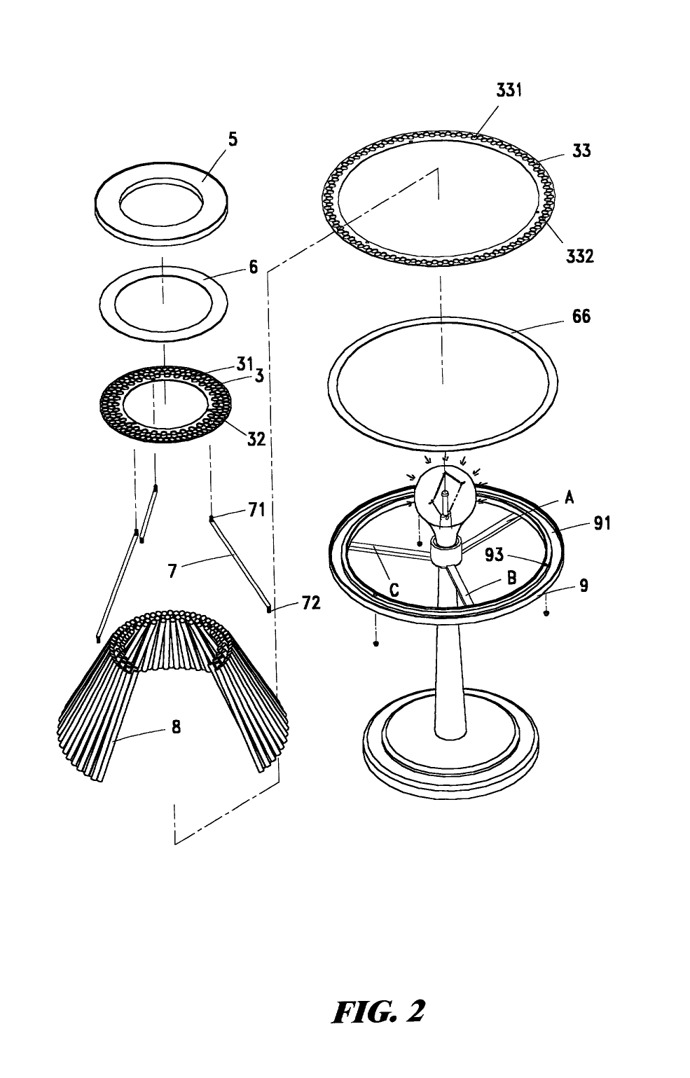

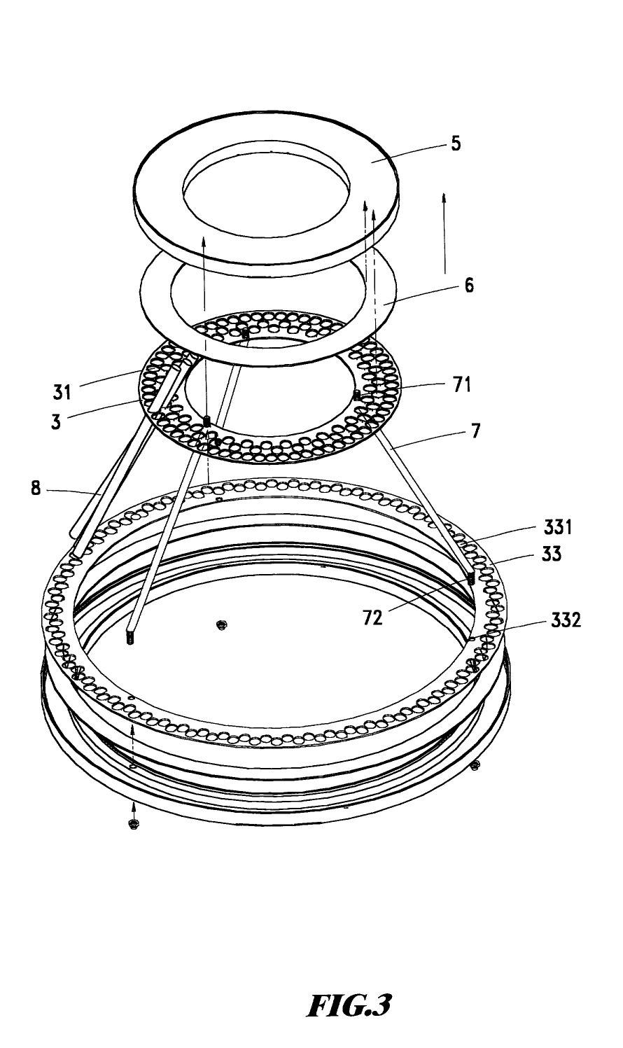

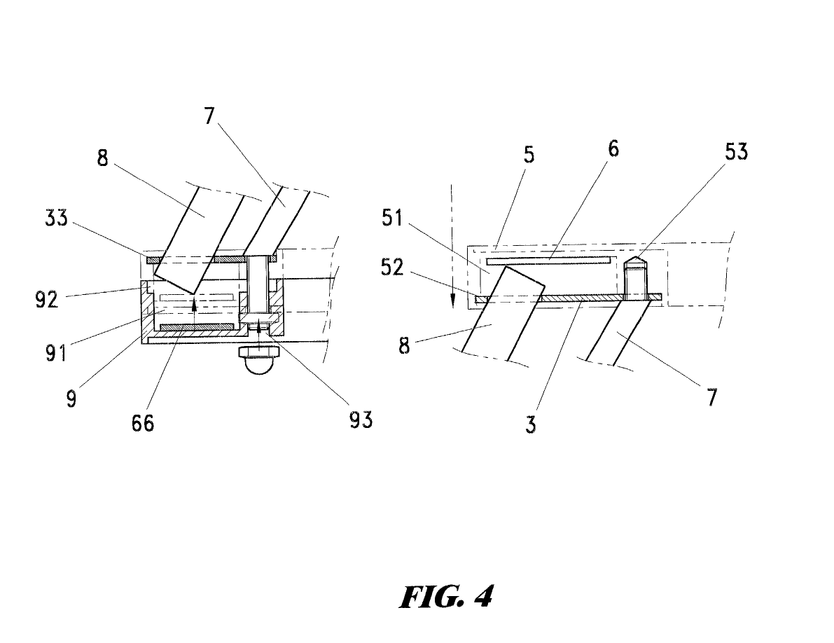

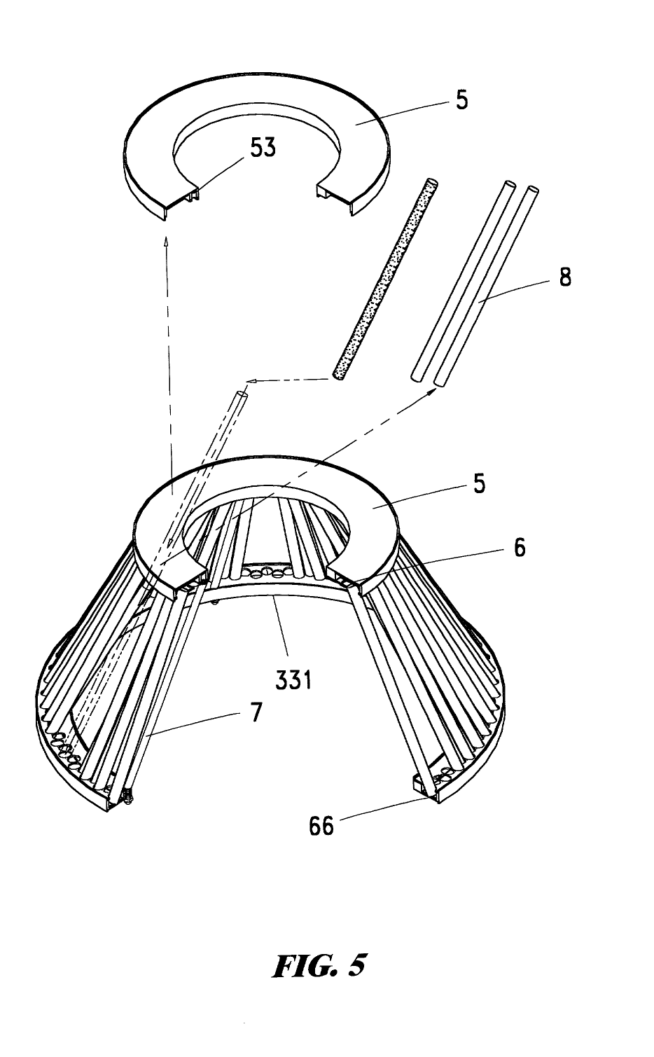

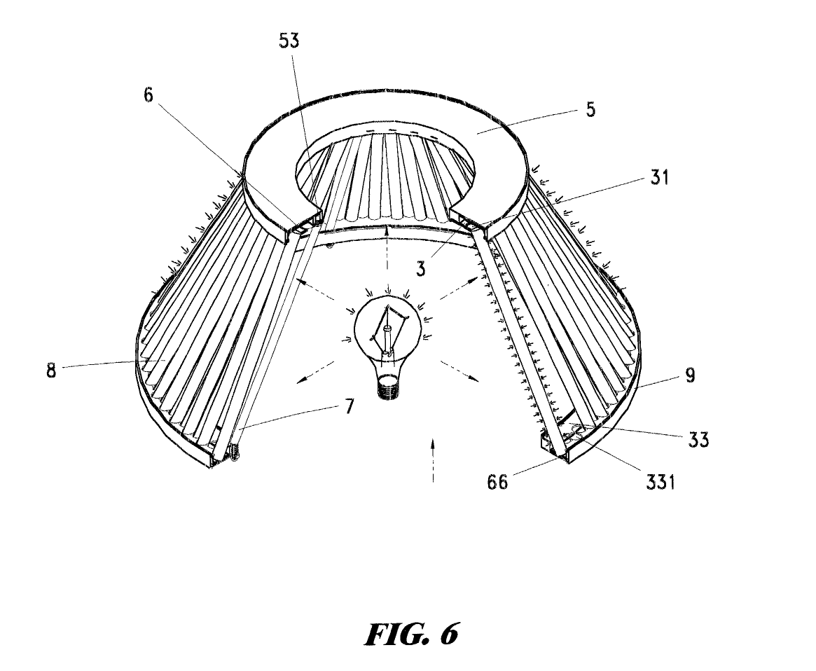

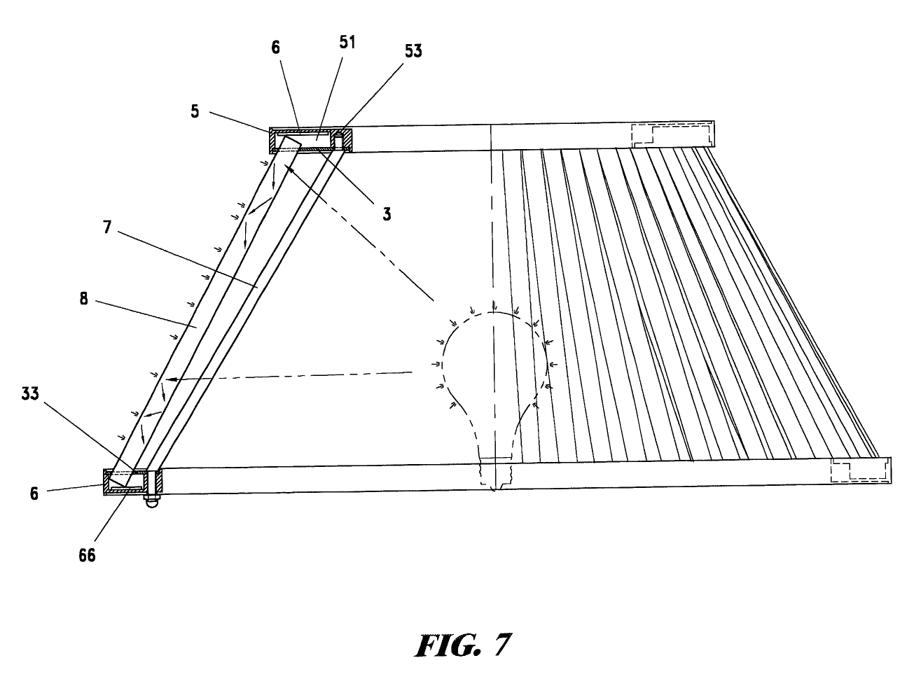

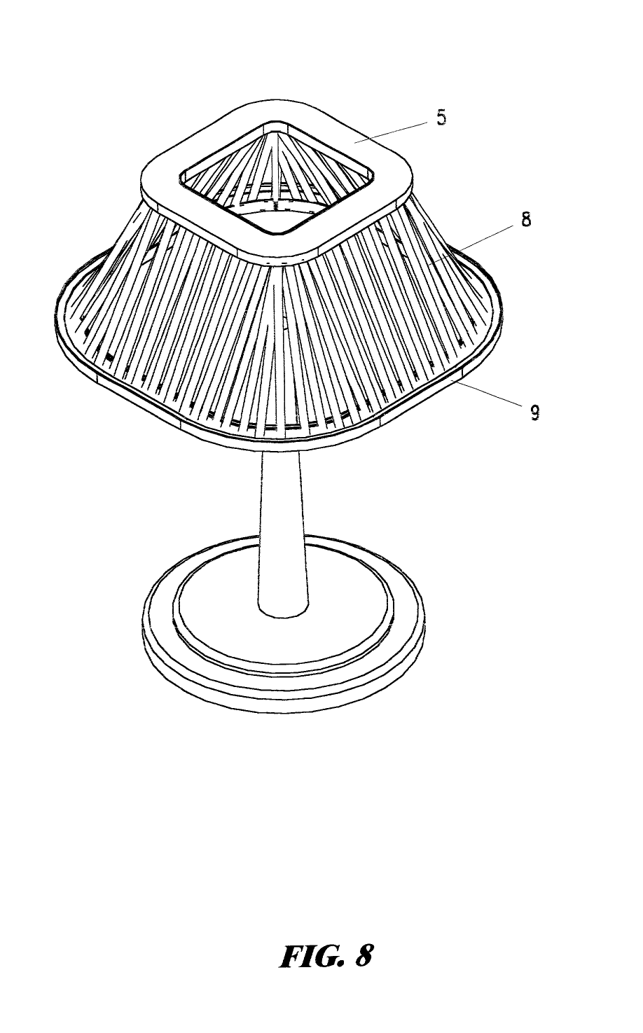

With reference to the drawings and in particular to FIGS. 1 through 8, this invention is about a variable, phantom, 3-D stand lamp. It consists of a cover disk, a circular pad, mesh-shaped circles, axes, glass rods and a base. The cover disk refers to the disk-shaped cover 5. Inside the cover disk, is a concave circle track (51). The margin of the circle track provides a circular surface 52 to hold the circle. On the circular surface are evenly distributed spiral holes 53 which hold the axes. The circular pad is a circular plastic of considerable elastic coefficient. The circular pad separates a small upper circular ring 6 from a lower circular ring 66, for its insertion into the cover disk. And it is also found in the concave circle track of the base, helping to fix the upper end and the lower end of the glass rods. The mesh-shaped circles are circular plates. On the margin of the upper circle 3 and the margin of the lower circle 33 are opposite, interlacing meshes 31 & 331. The mesh of the upper circle and the mesh of the lower circle are arranged in a slant. On the inner margin of the upper circle is a spiral hole 32 of fixed direction, while on the inner margin of the lower circle are evenly distributed shuttle holes 32 & 332 for the axes. The axes refer to circular rods 7. The upper end and the lower end of circular rods 7 are bent toward the vertical planes 71 & 72. The bending portion has a spiral surface for attachment. The glass rods refer to transparent glass rods 8. Each glass rod can hold a colorful body. The base refers to the circular base 9, and it contains a concave circle track 91. On the margin of the circle track provides a circular surface 92 to hold the lower circle. On the circular surface are evenly distributed spiral holes 93, which hold the axes, and the spiral holes are opposite to the cover disk.

Below is the description showing how to assemble the components of this invention. The base is attached to the supporting plates A, B & C of the base of the stand lamp, with its circle track facing upward. Point the bending portion of the lower end of an axis at the spiral hole of the inner margin of the upper circle, and screw them together. Pass the bending portion of the lower end of an axis through the evenly distributed shuttle hole of the lower circle, then point the bending portion of the lower end of the axis at one of the evenly distributed holes found on the base, so that the mesh-shaped upper circle and the lower circle can form an erect structure. Insert the lower circular pad into the circle track of the base. Pass the colorful glass rods, one by one, through the interlacing mesh of the upper circle, and then the corresponding interlacing mesh of the lower circle, and eventually rest the glass rods on the pad inside the circle track. At this point, a netlike lampshade is formed. The glass rods, which are inserted into the interlacing meshes of the upper circle and the lower circle, are arranged in such a way that, inner and outer encircling glass rods are crossed in S-shaped curves but remain separated, allowing slots between themselves. Inside the netlike lampshade, which is formed by the encircling glass rods, is a light bulb. The light emitted by the light bulb pass through the slots between the glass rods, thus the light is partly hidden and partly visible. Insert the upper circular pad into the concave circle track of the cover disk. The cover disk covers the upper margin of the mesh-shaped upper circle. The structural combination is of practical usage, that is, the colors of the light passing through the glass rods are bright, interlacing and variable. The combination of colors can be adjusted and matched freely, according to the surroundings, thus enhancing its function of polychrome, phantom, project light source.

I claim:

1. A variable, phantom, 3-D stand lamp, which consists of a cover disk, a circular pad, mesh-shaped circles, axes, glass rods and a base, etc.
The cover disk is disk-shaped cover, in which is a concave circle track. The margin of the circle track provides a circular surface to hold the circle. On the circular surface are evenly distributed spiral holes that hold the axes,
The circular pad is a circular plastic, and it separates a small upper circular ring from a lower circular ring, for its insertion into the cover disk. And it is also found in the concave circle track of the base, helping to fix the upper end and the lower end of the glass rods,
The mesh-shaped circles are circular plates. On the margin of the upper circle and the margin of the lower circle are opposite, interlacing meshes. The mesh of the upper circle and the mesh of the lower circle are arranged in a slant. On the inner margin of the upper circle is a spiral hole of fixed direction, while on the inner margin of the lower circle are shuttle holes for the axes,
The axes are transparent circular rods. The upper end and the lower end of the axes are bent toward the vertical planes. The bending portion has a spiral surface for attachment,
The base is a circular base, and it contains a concave circle track. On the margin of the circle track provides a circular surface to hold the lower circle. On the circular surface are evenly distributed holes that hold the axes, and the holes are opposite to the cover disk,
The aforesaid combination is of practical usage, that is, the colors of the light passing through the glass rods are bright, interlacing and variable. The combination of colors can be adjusted and matched freely, according to the surroundings, thus enhancing its function of polychrome, phantom, project light source.

2. A variable, phantom, 3-D stand lamp according to claim 1, this invention is about a variable, phantom, 3-D stand lamp. It consists of an upper circle and a lower circle. Between the two circles are three axes that divide the space. Colorful glass rods are inserted into meshes paired opposite in the upper circle and the lower circle respectively.

3. A variable, phantom, 3-D stand lamp according to claim 1, this invention is about a variable, phantom, 3-D stand lamp. The inner and outer encircling glass rods are crossed in curves but remain separated, and the ends of the glass rods seem to project colorful light as if they are light sources.
